(19) United States
(12) Patent Application Publication
(10) Pub. No.: US 2006/0104709 A1
(43) Pub. Date: May 18, 2006

(54) Adapter for securing documents in loose-leaf binder

(76) Inventor: Cecil C. Shrock, Colcord, OK (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/991,771

(22) Filed: Nov. 18, 2004

(51) Int. Cl. B42F 13/00

(52) U.S. Cl. 402/79

(57) ABSTRACT

An adapter to allow documents, small or large, to be mounted in a loose-leaf binder includes a substrate strip and a parallel adhesive tape strip that is partially overlapping (and thus secured to the substrate) and partially exposed (to secure to the document).

### BACKGROUND OF THE INVENTION

The present invention relates to document organization and the placement of documents into loose-leaf binders.

Paper documents can be stored in a variety of ways. Many businesses use a file folder having two holes punched at the top through which a 2-pronged attachment device extends, such as an Acco® paper fastener. A hole punch can be used to punch corresponding holes in a new document, extend the prongs through the holes, and then secure the prongs with a closure device. Another device may be called a file pocket which may contain loose documents or a file folder together with documents. One of the most popular devices for organizing and storing documents is the 3-ring loose-leaf binder. Such devices are ubiquitous in schools throughout the country. Predominantly, such loose-leaf binders use a 3-ring arrangement wherein a metallic or plastic structure is mounted along the inside of a spine of the binder. The mechanism typically has opposing tabs which are mechanically connected to engaging rings. The engaging rings are often circular, oval, or may have a “D” configuration. They do, however, open generally at or near the center of the ring so that upon depressing the opposing tabs, all of the rings of the loose-leaf binder open. Typically, the user punches holes in a document along the side margin, lengthwise, with a 3-hole punch and then places the document into the binder so that each of the three holes passes through a respective one of the three rings. The user then closes the tabs to close the engaging rings, whereupon the document is bound within the loose-leaf book.

A standard size paper in the United States is 8.5 inches×11 inches, and most 3-ring loose-leaf binders are arranged to have a slightly larger size so that they may hold such standard size paper. Loose-leaf binders come in a wide variety of thicknesses, but the vast majority of such binders use three rings and are designed for this standard size paper. Thus, their paper capacity is a variable which a user can consider when purchasing a 3-ring binder. That is, the user may purchase a binder in the ½ inch thickness size, 1 inch, 2 inch, 3 inch, and other sizes.

However, a problem arises when a user wants to place a document that is smaller than the standard 8.5 inch×11 inch size into the 3-ring binder. If the document has a height that is on the order of 5 inches or more, then that document can be punched at the left margin with two holes of standard spacing corresponding to the space between rings in a 3-ring binder, and two adjacent ones of the three rings of the 3-ring binder, as the user selects, can be used to secure the document in the binder. This solution, however, is not always acceptable. For example, business cards are even smaller than this and cannot easily be placed in a standard 3-ring binder. Newspaper articles present another problem because the text on the document may be so close to the margin that upon punching the document, important text is lost. Other documents that a user may wish to store in a 3-ring binder include greeting cards from family members and friends. These are generally not 8.5 inches×11 inches but come in a variety of sizes, generally smaller than 8.5 inches×11 inches. Additionally, one generally would prefer not to punch such documents. Accordingly, some adapter device is needed for securing such documents.

One approach that has been followed is to use sleeves that are pre-punched on the left margin and which contain pockets into which documents can be placed. That solution works for some documents but has limited flexibility. For example, an adapter for holding standard size business cards in a 3-ring binder will generally be unsuitable for securing documents of other sizes.

The present invention seeks to provide an economical, easy to use, highly flexible adapter that is usable on virtually all size documents that fit within a binder having engaging rings that open and close.

### SUMMARY OF THE INVENTION

The present invention has various aspects and is defined by the claims. However, according to various of its aspects, the present invention uses a substrate strip. Preferably a set of holes is arranged generally linearly along the strip so that an 11 inch length of the strip can be secured in a 3-ring binder, illustratively. Further, a tape strip is affixed to the substrate strip lengthwise so that a portion of the tape extends beyond the side margin of the strip. Such exposed portion of the tape will adhere to the documents to be bound into the loose-leaf binder. Alternatively, a strip of adhesive is located along a right margin of the substrate.

### BRIEF DESCRIPTION OF THE DRAWINGS

FIG. 1 represents an illustrative top view sketch of a preferred embodiment of the present invention;

FIG. 2 shows how the device of FIG. 1 can be used; and

FIG. 3 shows an alternate embodiment.

### DESCRIPTION OF A PREFERRED EMBODIMENT

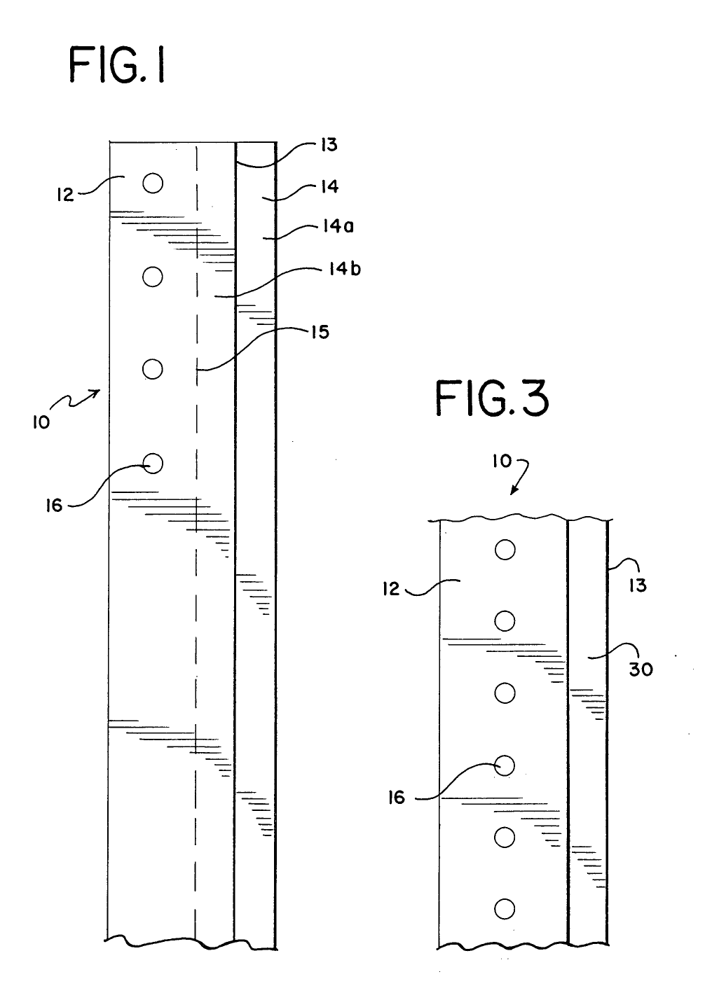

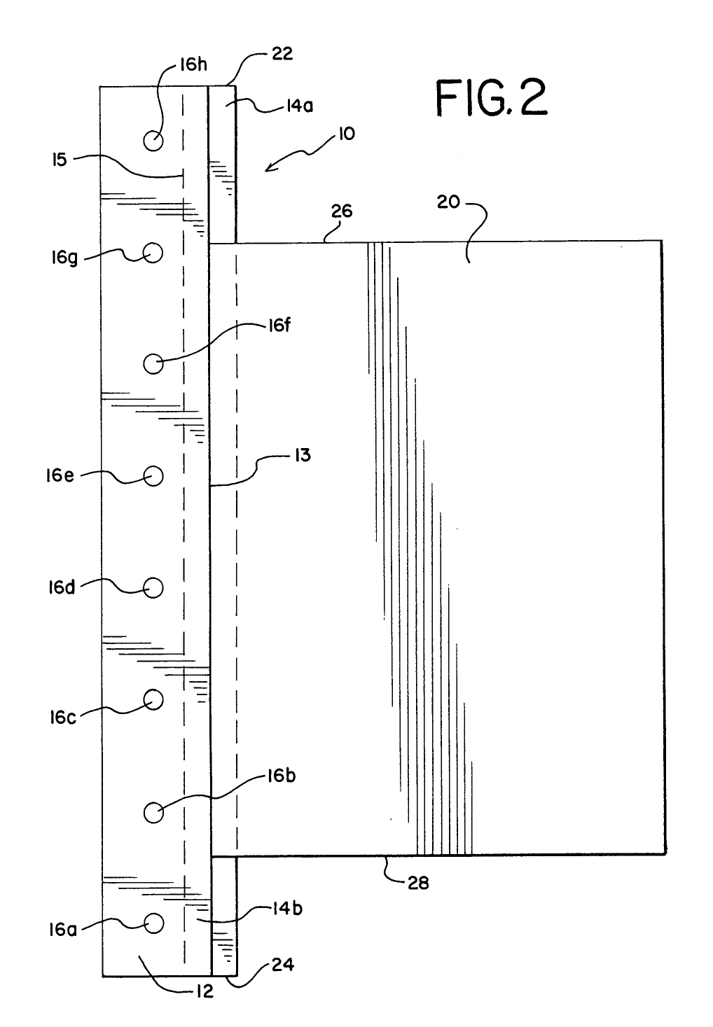

An adapter 10 according to aspects of the present invention is shown in the accompanying FIGS. 1-2. Adapter 10 comprises a substrate 12 which is generally in the form of a strip having a right side edge 13. An overlapping parallel strip of adhesive tape 14 or the like is shown in FIG. 1. Tape 14 overlaps the right side edge 13, with portions on either side thereof. Specifically, tape 14 has an exposed portion 14a which is located to the right of edge 13 and thus is not covered by the substrate 12. It also has an overlapping portion 14b which is located to the left of edge 13 and is adhered to the back, illustratively, of the substrate strip 12. The broken line 15 extending vertically in FIG. 1 indicates the left edge of the adhesive tape 14.

A set of holes 16 is preferably but not necessarily pre-punched into the substrate strip 12. Such holes are preferably evenly spaced with approximately 10 or 11 holes per 11 inch span of adapter 10. The holes may be spaced apart approximately 1.125 inches center to center, and illustratively are ¼ inch diameter round holes. Other holes can be used. The holes should be spaced so that an 11-inch span of adapter 10 can be mounted into a standard 3-inch binder via three of the holes 16.

Illustratively, the width of substrate 12 is nominally 1 inch. It may, however, be slightly more or slightly less, although a width in the range of 0.75 inch to 1.25 inch is advantageous.

The tape 14 is illustratively 1 inch wide tape but can depart from that nominal width and can be, for example, 0.5 inches wide or more. Preferably the tape is adhesive tape having adhesive on one side only so that at least 0.25 inches of tape extends in area 14a and so that region 14b is also at least 0.25 inches wide. The tape 14 can, however, be wider so that it overlaps even more of substrate 12. Indeed, if the tape 14 is sufficiently wide, then holes 16 may extend through tape 14 also. The tape can be even wider than substrate 12, if desired. Tape 14 can be, illustratively, a matte finish invisible tape of the type customarily used for home and office applications such as Scotch® tape catalog number 810 available from the Stationery Products Division of 3M in St. Paul, Minn. Alternatively, tape 14 may have a glossy finish. Tape 14 may be a removable or not removable style of tape.

Substrate 14 may be made of light or heavy weight paper, a light cardboard, or another cellulose product, or can be a synthetic plastic product, as desired. Preferably it will not have excessive thickness because that would limit the number of documents that can be placed in a given loose-leaf binder. Substrate 12 may illustratively be made of paper of the type ordinarily used for business correspondence or photcopying.

Holes 16 are preferably at least ¼ inch in diameter although they may be slightly larger to facilitate insertion into the loose-leaf binder. The holes can be omitted in another embodiment, so that the user would employ a hole punch at an appropriate time.

As represented by FIG. 1, tape 14 may be affixed to the rear side of substrate strip 12. That is, the adhesive side of tape 14 would be facing up in FIG. 1 so that the portion 14b is adhered to the rear side of substrate 12 and so that the exposed face 14a of tape 14 is adhesive. However, this could be reversed with the tape on top of substrate 12 and the adhesive part facing down instead of up.

Preferably, the substrate strip 12 and tape strip 14 are combined by the manufacturer and sold illustratively in rolls, much in the same manner as adhesive tape is sold for office use. A similar tape dispenser can be used also. Hence, for example, if substrate 12 is 1 inch wide and tape 14 is ½ inches wide, with an exposed margin 14a of ¼ inch and an overlapping portion 14b of ¼ inch, then the width of the combination is substantially 1.25 inches. This may be dispensed on a modification of a tape dispenser available from many office product suppliers such as a C-38 desk dispenser available from 3M Products of St. Paul, Minn. Such a tape dispenser has a cavity slightly more than 1 inch wide and approximately 3.25 inches long, with a variable depth of the cavity. The cavity would be widened to accommodate the wider tape and can be lengthened if desired. The customary center roller or pin arrangement to support the tape in a channel can be provided, and the same cutting bar or other cutter can be used. Hence, the adapter 10 of the present invention can be sold in coils for dispensing in exactly the same manner as rolled adhesive tape is dispensed in offices or homes. The adhesive exposed portion 14a of the tape strip 14 can be either face down or face up on the roll, as the provider desires.

FIG. 2 is used to explain the use of adapter 10. Consider a user who desires to place a document 20 such as a newspaper article in a 3-ring loose-leaf-book. Illustratively, the newspaper article is about 4 inches wide and about 6 inches tall. Assume that the adapter 10 is available on a dispenser roll. The user dispenses a strip that is somewhat longer than the 6 inch height of the newspaper article, e.g. dispenses a strip with a length of about 8 inches. Such a strip is shown in FIG. 2 and, as shown, includes evenly spaced holes 16a, 16b . . . 16h. (It will be understood that the holes do not need to be evenly spaced.) He affixes the left margin of the newspaper article to the adapter 10 by placing the left margin of the document on top of the exposed adhesive tape portion 14a. Typically, he aligns the left edge of the document 20 with the right edge 13 of the substrate strip 12. Then he secures the connection by manually pressing the two together to ensure there is satisfactory adhesion. He may then insert the 8″ strip into the loose-leaf binder at a position so that its top 22 does not rise above the top of the engagement ring mechanism and so that its bottom 24 does not descend below the bottom of the mechanism. There will be some top or bottom unused portion of adapter 10 which the user can either cut with a scissor or, alternatively, the user may leave the excess top and/or bottom portions in place and cover the exposed adhesive tape 14a with a piece of another adhesive tape so that no part of adhesive tape 14a remains exposed after the installation. These alternatives may be referred to as a finishing step.

If desired, the user can employ a strip of adapter 10 that is substantially 11 inches long so that it will engage all three rings of a common 3-ring binder. That is, adapter strips 10 can be pre-cut and sold in this length, or the user can dispense such a length from the previously mentioned roll. He may place the newspaper article at any location along the strip, whether top, middle, or bottom, and can then use the remaining unused portion for other documents to be secured to the binder or can then apply adhesive tape on the top of the combination to cover exposed portions 14a of tape 14 that remain after placement of the document. Thus, in FIG. 2, after affixing document 20 onto the exposed portion 14a of tape 14, the user may place a piece of see-through adhesive tape on top of document 20 at the left margin of the document from top margin 22 to bottom margin 24, thus covering the exposed portions 14a. Alternatively, the user can trim off the portions of adapter strip 10 above the upper margin 26 of document 20 and below the bottom margin 28 of document 20, and use holes 16f and 16b for mounting document 20, affixed to the adapter 10, in two selected rings of a 3-ring binder.

It will be appreciated that adapter strip 10 can be supplied in pre-cut lengths of 11 inches or any other length desired by the seller. Its manner of use corresponds to the descriptions just given for either the rolled strip or the 11-inch strip.

Adapter 10 and other embodiments of the present invention provide a highly flexible mounting system and method for mounting documents in a loose-leaf binder. The binder generally takes the form of a 3-ring loose-leaf binder but may comprise a binder with other ring arrangements, and no particular number of rings limits the application of the present invention. Documents to be mounted may have virtually any width or any height, provided, of course, that they fall within the confines of the loose-leaf binder or, alternatively, that the user is content to allow them to be folded or extended beyond the outer margins of the notebook even after being mounted therein. Salutary advantages of the present invention are that the adapter 10 need not be fabricated in numerous different sizes to accommodate different sized documents, that a single strip can accommodate a wide variety of documents, and that it can be dispensed from a roll in a manner long familiar to consumers.

It will be understood that the adapter 10 can be provided without holes 16 so that the user, after mounting his document on a strip of the adapter 10, can then use a hole punch for making holes in the appropriate locations, as desired.

Another modification of the present invention is shown in FIG. 3. This is similar to the preferred embodiment of FIG. 1 except that a separate tape 14 is not combined with the substrate strip 12. Instead, the substrate strip 12, which has a right edge 13, includes an adhesive region 30 corresponding to exposed adhesive region 14a of the first embodiment. That is, an adhesive material is applied to the substrate 12 but only along a lengthwise strip at the right margin of substrate 12, leaving an exposed adhesive region 30 performing exactly the same function in exactly the same way as region 14a. Preferably, region 30 is at least 0.25 inches in width.

Further modifications and changes will become apparent to persons skilled in the art after consideration of this description and drawings. The scope of the invention is preferred to be defined by the appended claims and equivalents thereof.

1. An adapter for securing documents in a loose-leaf binder having engaging rings, the adapter comprising:
a substrate strip, said strip being cuttable with a scissor;
a strip of adhesive tape affixed parallel to said substrate strip so that an exposed length of said tape extends laterally beside said substrate, said exposed length being sufficient to attach to a document so that said document is joined to said substrate strip by said adhesive tape.

2. The adapter of claim 1 wherein said substrate strip further comprises a set of holes arranged generally linearly therealong, said holes being of size and spacing to permit the engaging rings of the loose-leaf binder to pass through selected ones thereof.

3. The adapter of claim 2 wherein said adapter is coiled in a roll for dispensing a length thereof in a user-selected length.

4. The adapter of claim 2 wherein said substrate strip has a width of about 0.75 inches.

5. The adapter of claim 2 wherein the substrate strip has a width of about 1 inch.

6. The adapter of claim 2 wherein said tape has an exposed width of at least 0.25 inches.

7. The adapter of claim 6 wherein said tape has a width of at least 0.5 inches.

8. An adapter for securing documents in a loose-leaf binder having engaging rings, the adapter comprising:
a substrate strip that is cuttable with a scissor; and
a laterally-offset, lengthwise-oriented stripe of adhesive located upon said substrate strip, parallel to an edge thereof, said adhesive stripe being located on only a right margin of said substrate strip, said adhesive stripe being effective for adhering to a document,
a left portion of said substrate strip not having an effective amount of adhesive thereon for adhesion to a document to be mounted.

9. The adapter of claim 8 wherein said substrate strip further comprises a set of holes arranged generally linearly therealong, said holes being of size and spacing to permit the engaging rings of the loose-leaf binder to pass through selected ones thereof.

10. The adapter of claim 8 wherein said adapter is coiled in a roll for dispensing a length thereof in a user-selected length.

11. The adapter of claim 8 wherein said substrate strip has a width of about 0.75 inches.

12. The adapter of claim 8 wherein the substrate strip has a width of about 1 inch.

13. The adapter of claim 8 wherein said adhesive stripe has a width of at least 0.25 inches.

14. The adapter of claim 9 wherein said adapter is coiled in a roll for dispensing a length thereof in a user-selected length;
wherein said substrate has a width of at least 0.75 inches; and
wherein said adhesive stripe has a width of at least 0.25 inches.

15. The adapter of claim 9 wherein said adapter is coiled in a roll for dispensing a length thereof in a user-selected length;
wherein said substrate has a width of at least 15 millimeters; and
wherein said adhesive stripe has a width of at least 5 millimeters.

16. A method of securing a document to a loose-leaf binder having engaging rings comprising the steps of:
dispensing an adapter strip having a length generally commensurate with the length of the document, said adapter strip having first and second parallel, lengthwise portions, said second portion including an exposed adhesive portion;
affixing said document to said strip via said exposed adhesive portion;
finishing said adapter strip after said affixing step; and
engaging said adapter strip after it has been affixed to said document with said binder engaging rings.

17. The method of claim 16 wherein said finishing step comprises adding a tape over remaining exposed adhesive portion of the adapter strip.

18. The method of claim 16 wherein said finishing step comprises trimming off portions of the adapter containing unused portions of the adhesive portion.

19. The adapter of claim 2:
wherein a portion of said adhesive tape strip overlaps at least a portion of said substrate strip; and
wherein said adhesive tape strip is substantially transparent.

20. The adapter of claim 19:
wherein said substrate strip has a width between approximately one-half and one inch;
wherein said adhesive tape strip has a width between approximately one-half and one inch;
wherein the portion of said tape that is laterally beside said substrate has a width of at least approximately one-fourth of one inch;
wherein the spacing of said holes is such that multiple said holes are located between adjacent rings of a loose-leaf binder.
